(19) United States
(12) Patent Application Publication
(10) Pub. No.: US 2002/0168058 A1
(43) Pub. Date: Nov. 14, 2002

(54) Passive telecommunication monitor system

(75) Inventor: Bruce Graham Gailbraith, Kwa Zulu Natal (ZA)

Correspondence Address: YOUNG & THOMPSON, 745 SOUTH 23RD STREET 2ND FLOOR, ARLINGTON, VA, 22202

(73) Assignee: AFRICA DEVELOPMENT ENTERPRISES CC, KWA ZULU NATAL (ZA)

(21) Appl. No.: 10/187,845

(22) Filed: Jul. 3, 2002

Related U.S. Application Data
(63) Continuation of application No. 09/199,457, filed on Nov. 25, 1998.

(30) Foreign Application Priority Data
Dec. 26, 1997 (ZA) 97/10622

(51) Int. Cl. H04M 15/00; H04M 1/24

(52) U.S. Cl. 379/133; 379/22.03

(57) ABSTRACT

A passive system for monitoring a voice, data, image, text or other telecommunication media by a customer has means to connect the line to be monitored, a processing unit which measure the signals passing through the line means to compare these measured signals with predetermined values, or monitors the progress of a call; and means of indicating the status of the line as determined by the comparison or cell progress monitor, by visual or audible alarm or display.

### FIELD OF THE INVENTION

This invention relates to a passive system for monitoring of a voice, data, image, text or any other telecommunication media by a customer of a telecommunication network provider, and in particular for passive monitoring and fault finding on the line between the customer's switching device or terminal equipment, and the telecommunication network exchange.

### BACKGROUND OF THE INVENTION

At present telephone customers or computer operators using telephone, leased lines, and circuits using copper, fibre, coaxial cable, radio, satellite, microwave or any other telecommunication media could be unaware of a fault with their system, or on the line itself. Often several hours or even days may pass before the phone is picked up (or the computer accessed) and a fault is discovered, and with particular regard to businesses, this could result in serious communication problems. Even when the fault is discovered there is no way of the customer knowing what the cause of the fault is, and either the network service provider or the technicians of the private automatic exchange, or both, must be called to diagnose the fault.

Often there is a duplication of costs as the incorrect party is contacted and then further complications and delays resulting from difficulties in apportioning fault to either or both parties.

It is therefore an object of this invention to provide a passive system to monitor such lines, whether data, voice, image, text etc. and to not only warn of the existence of a fault or impending occurrence of a fault, but also to diagnose the fault in order that the correct party may be contacted to rectify the fault, in so doing expediting repair.

It is a further object of the invention to provide a system for monitoring both single line and multiple line systems as well as single line systems having multiple applications such as for modem, fax or telephone.

The system allows a user to monitor many lines in different locations and assemble and process this information for statistical analysis. This system has the flexibility to interface with the equipment from the telephone company that provides the circuits to the customer's premises, at a point of technical feasibility in compliance with the telecommunications act and the relative license conditions.

### THE INVENTION

According to the invention, a passive monitoring system for telecommunication lines includes:

means to connect the line to be monitored,

a processing unit adapted to measure the signals passing through the line and

a means to compare the measured values to predetermined values, and/or monitor the progress of a call, and

a means of indicating the status of the line as determined by the comparison and/or the call progress monitor, via a visual and/or audible alarm or display.

In the preferred form of the invention, the system first determines the static state of the line by the process of comparison and thereafter if the static state of the line is satisfactory, determines the dynamic state of the line by monitoring the progress of a call. By establishing at what stage a call is aborted or cannot proceed further, the processing unit determines the fault present.

In the preferred form of the invention, communication means, for example a modem, may be provided in order to communicate the status to a remote location.

The processing unit may include means adapted to perform tests to identify the cause of line faults.

The system may be adapted to engage all forms of solid telecommunications media including copper wire or cable, fibre optic, coaxial cable, radio, satellite, microwave or other landline or solid channelling system.

The system of the invention allows a customer to monitor and test his or her own lines and either act promptly to rectify fault or even pre-empt the occurrence of a fault. This differs from prior art monitoring systems in that it is a tool of the customer rather than the service provider. This fact necessitates a passive system which in no way interferes with the line or any flow of signals or pulses therethrough. Prior art system are primarily service provider orientated and generally involve an active interaction with the cabling over long distances.

A further advantage of the system is that the customer does not require technical skill to determine the fault. The fault, or a coded representation thereof, will be displayed by the invention. In the past, a customer would have to rely on the licensed telecommunications operator to provide technical assistance to determine the fault.

### EMBODIMENT OF THE INVENTION

An embodiment of the invention is described below with reference to the accompanying drawings in which:

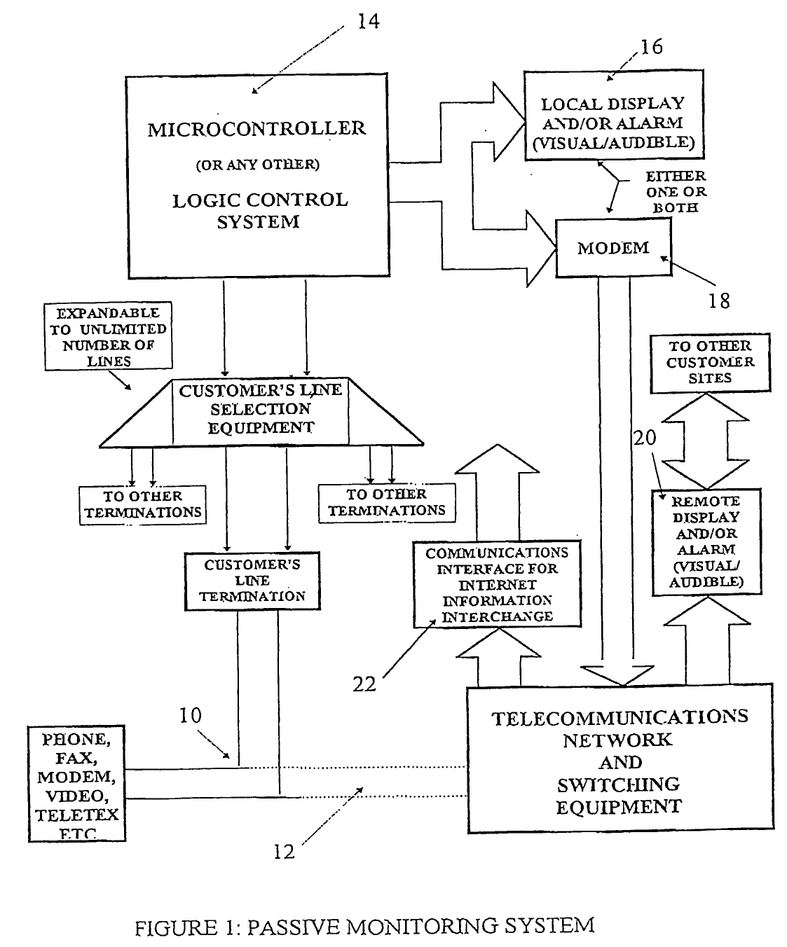

FIG. 1 is a block diagram of the system according to the invention.

In the drawing a passive, customer-based telephone line or data line monitoring system is shown to comprise a parallel connection at 10 to the customer's line 12 to the network. The same principle of operation applies to both single line customers and multiple line customers which include line selection equipment.

Processing unit 14 measures the signals or pulse passing through the customer's line(s) and compares the information received to predetermined values and determines the status of the line or lines. If the comparison is satisfactory, the progress of a call is monitored and the status of the line is then displayed on screen 16 which display may include an audible alarm. A connector in the form of a modem 18 is provided to relay the status to a remote location 20 which may be the licensed telecommunications operator or other customer's sites. 22 is a communications interface (for Internet Access) to exchange information front the telecommunications operator.

1. A passive monitoring system for telecommunication lines includes:
means to connect the line to be monitored,
a processing unit adapted to measure the signals passing through the line and
a means to compare the measured values to predetermined values, and/or monitor the progress of a call, and
a means of indicating the status of the line as determined by the comparison and/or the call progress monitor, via a visual and/or audible alarm or display.

2. The passive monitoring system according to claim 1 in which the system first determines the static state of the line by the process of comparison and thereafter if the static state of the line is satisfactory, determines the dynamic state of the line by monitoring the progress of a call.

3. The passive monitoring system according to claim 1 in which the system is adapted to establish at what state a call is aborted or cannot proceed further, the processing using determining the fault present.

4. The passive monitoring system according to claim 1 in which a modem is provided in order to communicate the status to a remote location.

5. The passive monitoring system according to claim 1 in which the processing unit includes means adapted to perform tests to identify the cause of line faults.

6. The passive monitoring system according to claim 1 which is adapted to engage all forms of solid telecommunications media including copper wire or cable, fibre optic, coaxial cable, radio, satellite, microwave or other landline or solid transmission media.
